(19) United States
(12) Patent Application Publication
(10) Pub. No.: US 2010/0008836 A1
(43) Pub. Date: Jan. 14, 2010

(54) APPARATUS FOR CRACKING THE MOLECULAR STRUCTURE OF LONG CHAIN ORGANIC SUBSTANCES

(75) Inventor: Giorgio Pecci, Aguscello (IT)

Correspondence Address: DENNISON, SCHULTZ & MACDONALD, 1727 KING STREET, SUITE 105, ALEXANDRIA, VA, 22314, US

(73) Assignee: ENERCUT S.R.L., Ospedaletto (IT)

(21) Appl. No.: 12/375,442

(22) PCT Filed: Aug. 13, 2007
(86) PCT No.: PCT/IB07/02335

§ 371 Date: Feb. 11, 2009

(30) Foreign Application Priority Data
Aug. 11, 2006 (IT) BO2006A000603

(51) Int. Cl. B01J 19/00

(52) U.S. Cl. 422/229

(57) ABSTRACT

An apparatus for cracking organic substances, for making a mixture of solid and/or liquid and/or gaseous components. The device comprises a cracking chamber (5) with substantially tubular walls arranged between an inlet port (β) of said organic substances and an outlet port (7) of the mixture. In the chamber (5) a rotor shaft is arranged (23) associated with rotary actuating means (24) of the rotor shaft (23) with respect to the walls of the chamber in such a way that the cracking occurs by friction of the substances during the relative rotation between the rotor shaft (23) and the walls of the cracking chamber (5). A feeding device pushes the substances in the cracking chamber (5), where they are subject to a high speed mixing action owing to the rotor shaft (23), and a variable gap (S) adjusts the friction, in particular, in a first tubular section (20) of the chamber (5), so that the transformation temperature reaches a desired value. Then the products pass through the gap (S), from the first tubular section (20) to a second tubular section (21), which may have diameter larger than the first and where the transformation is completed, and then are transferred to a degassing device through the outlet port (7).

### FIELD OF THE INVENTION

The present invention relates to an apparatus for transforming solid long chain organic substances, by a cracking process, producing a mixture of solid and/or liquid and/or gaseous components. In particular, the molecular chains of said solid substances are turned into a mixture of solid and/or liquid and/or components. Among the long chain organic substances subject to cracking there are natural substances, like biomasses of various type, lignin, wood in general, oils and fats, amines, waste from leather and meat industry, meat and bone meals; and synthetic substances, mainly polymers, such as rubbers, for example used tyres, plastics of all types, synthetic fibres.

### BACKGROUND OF THE INVENTION

As well known, a variety exists of devices adapted to transform solid organic substances with long chain chemical bonds; such devices have normally a rotor, for example a screw shaft, operated to turn in a respective cylindrical chamber heated by an external source, thus obtaining a suitable temperature profile. The rotor has generally simply the task of assisting the conveyance of the mass of substances. In some cases, the rotation of the screw shaft determines, by mixing continuously the substances at a high speed, an intense friction against the inner walls of the chamber. The friction causes a heating that adds to the heat supplied from the outside and exchanged through the walls of the chamber. The overall heat can produce the desired transformations, so-called “cracking”, of the long chain substances into a mixture of solid, liquid and gaseous short chain substances, typically hydrocarbons and derivatives thereof. This cylindrical chamber ends at a mixture collecting device, which has also the task of separating the solid, which can be recovered for other processes or recycled in other ways, from the liquid and the gas, which are substances that can be reused, for example as fuel or combustible material.

Therefore, in the known devices the cracking is carried out mainly by supplying thermal energy, for surface heating, that is much greater and different from frictional heating cause by the rotor, with subsequent lower advantages in terms of energy balance and practical convenience. The cracking reactions, furthermore, are normally activated using a catalyst.

The devices of prior art have some important drawbacks.

Firstly, there is a difficulty in the control and in the regulation of the temperature obtained in the cylindrical chamber, which is a critical aspect since the above described transformation of substances should be carried out at determined temperatures. More in detail, significant differences in the features of the long chain substances loaded in the device can cause high temperature differences in the chamber: in other words, when loading in the same device different substances, different results are obtained in terms of shear stress and temperature profile and then quality of the transformation achievable.

Secondly, devices for collecting and separating the mixture are presently used that do not allow separating effectively the solid from the liquid and gaseous products, since the solid components tend to gather together and to accumulate, thus undesirably obstructing discharge ports and a free outflow of the light components.

Thirdly, the devices of prior art do not prevent the inlet of air when loading solid loose material in the cracking chamber, causing purely oxidative phenomena that, especially with determined types of material, can compete with the cracking reactions and bring to lower quality products.

Fourthly, a contemporaneous loading and measuring of different species of material to be cracked according to desirable proportions is not provided in the known apparatus.

A further problem is the presence of instable substances in the mixture of solid, liquid or gaseous substances, for example substances with double bonds, which can lead to undesirable polymerizations.

Finally, a separation of the solid from the liquid and gaseous substances can be problematic for carbon residues that can jam the ducts or block the moving parts that assist the separation.

### SUMMARY OF THE INVENTION

It is then an feature of the present invention to provide an apparatus for transforming organic substances having long chain chemical bonds into a mixture of solid and/or liquid and/or gaseous short chain components, typically hydrocarbons and derivatives thereof, for controlling in a precise and effective way the transformation conditions of such substances, in order to obtain components of a desired quality independently from the features of the substances during the transformation steps, in particular viscosity.

It is also an feature of the present invention to provide an apparatus for transforming organic substances having long chain chemical bonds into a mixture of solid and/or liquid and/or gaseous short chain components, for separating effectively, and without undesired accumulation of material, the resulting solid components from the liquid and gaseous components, so that they can be exploited independently in special plants, with more favourable outputs with respect to conventional waste-to-energy systems.

It is another feature of the present invention to provide a transformation apparatus that is fed without air and following predetermined recipes taking into account different proportions of the treated material.

It is a further feature of the present invention to provide an apparatus that is structurally simple, relatively easy, safe and effective to operate, as well as relatively cheap.

It is also a feature of the present invention to provide a transformation apparatus that reduces the presence of instable substances in the resulting products.

It is finally a feature of the present invention to provide a transformation apparatus that reduces the deposits of carbon residues during the separation steps.

These and other features are accomplished with one exemplary apparatus for cracking organic substances, for creating a mixture of solid and/or liquid and/or gaseous components, said apparatus comprising a cracking chamber, said cracking chamber having substantially tubular walls and being arranged between an inlet port for said organic substances and an outlet port for said mixture, in said chamber a rotor shaft being arranged associated with rotary actuating means adapted to cause the rotation of said rotor shaft with respect to the walls of said chamber, in such a way that said cracking occurs during the rotation by a frictional shear of said substances between the rotor shaft and the walls of said cracking chamber. The main feature of the apparatus, according to the invention, is that the cracking chamber is defined by a first segment and a second segment, wherein, between said segments in a direction from said inlet port and said outlet port, said chamber has a passageway from said first segment to said second segment, said rotor shaft having a portion that faces said passageway defining a gap, means being provided for adjusting said gap.

In particular, the means for adjusting said gap comprises means for generating a relative axial movement between the rotor shaft and the chamber.

Alternatively, the means for adjusting said gap comprises means for changing the shape of said rotor shaft or of said chamber, in particular, by means of mobile surface portions, such as valve portions, expanding portions, etc., arranged at said passageway and/or at a portion of the rotor shaft that faces said passageway.

Advantageously, the second segment has a diameter larger than the first segment. In particular, the ratio between the diameters of said second segment and said first segment is set between 2 and 4.

According to another aspect of the invention, a device is provided for cracking organic substances, for creating a mixture of solid and/or liquid and/or gaseous components, said apparatus comprising a cracking chamber, said cracking chamber having substantially tubular walls and being arranged between an inlet port for said organic substances and an outlet port for said mixture, in said chamber a rotor shaft being arranged associated with rotary actuating means adapted to cause the rotation of said rotor shaft with respect to the walls of said chamber, in such a way that said transformation occurs during the rotation by a frictional shear of said substances between the rotor shaft and the walls of said cracking chamber, whose main feature is that the cracking chamber is defined by a first segment and a second segment, and wherein, between said segments in a direction from the inlet port and the outlet port, the cracking chamber has a passageway from the first segment to the second segment, said second segment having a diameter larger than the diameter of the first segment.

Advantageously, the passageway has substantially frustoconical shape, and the portion of the rotor shaft that faces the passageway is also frustoconical and is adapted to move for adjusting its engagement degree with the passageway. Alternatively to the frustoconical shape, profiles can be provided with an increasing diameter from the first to the second segment having complex or curvilinear shape.

In particular, the rotor shaft has a plurality of substantially radial projections for centering the screw shaft in the cracking chamber. Said projections can also assist mixing the substances present in the cracking chamber.

Preferably, the rotor shaft has a helical profile, in particular is a screw shaft, and comprises a first portion that defines a first thread and a second portion that defines a second thread, of different pitch from each other. In particular the second thread has pitch larger than the first thread.

Advantageously, the second portion of the rotor shaft defines a third thread having a pitch less than the second thread.

Advantageously, axial bidirectional translation means are provided comprising at least one box, connected to an driven shaft of the rotary actuating means, in which at least one joint is housed for connection to an engagement head of the screw shaft. In particular, the joint is mounted on side radial bearings and on a central thrust bearing and has a first end, rigidly connected to the engagement head, and a second end, slidingly coupled to a driven shaft. The bidirectional translation means comprise, furthermore, a plurality of actuators, in particular hydraulic cylinders, adapted to work on the screw shaft in an axial direction opposite with respect to the flow of the substances being transformed in the cracking chamber. In particular, the cylinders are housed in respective cylindrical housings provided on a face of a collar blocked at one end of the box and adapted to work on a ring that faces the central thrust bearing.

Advantageously, the hydraulic cylinders are of single-acting type biased by respective springs, and are fed hydraulically by means of respective channels made in the collar. The action of the hydraulic cylinders is adapted to cause the screw shaft to translate in a direction in order to oppose to the action of the flow of substances being transformed in the cracking chamber. The action of the flow of substances, instead, assists in the translation of the screw shaft in an opposite direction.

In particular, the hydraulic cylinders have respective hydro-pneumatic accumulators adapted to dampen pressure peaks in the cracking chamber. More in detail, the hydro-pneumatic accumulators are associated to respective pressure limiting valves, which cause the accumulators to open if in the cracking chamber a determined pressure is exceeded, in order to adjust the pressure and the temperature in the chamber as desired by the user.

Advantageously, said inlet port is supplied by a screw shaft feeding device. Preferably, at least two screw shaft feeders are provided in parallel, for adjusting different amounts of material according to desired recipes. In particular, said or each feeding device comprises at least one upper cyclone for loading the substances, at least one mixing and storing chamber equipped with at least one stirrer and at least one first lower screw shaft adapted to compact the substances and to convey them, in substantial absence of oxygen, into the cracking chamber.

Advantageously, a degassing device is provided associated with said outlet port, comprising at least one elongated substantially tubular jacket, with substantially vertical axis, in which at least two degassing screw shafts are rotatably supported associated with rotary actuators, said screw shafts being adapted to convey towards below any transformed solid components and towards the above any liquid and/or gaseous components.

The degassing device comprises, furthermore, a second screw shaft for extracting the solid components separately from the liquid and/or gaseous components, associated with a respective rotary actuator arranged at a predetermined angle with respect to a vertical direction, rotatably supported in a substantially tubular body having an upper discharge mouth and communicating with a lower discharge port of the degassing device. The substantially tubular body and the second screw shaft have a length suitable to be filled completely with compacted solid components to avoid any reverse flow of air.

Advantageously, the tubular jacket is associated with heating means to assist any liquid and/or gaseous components to go up and the solid components to go down.

In particular, the degassing screw shafts are arranged at a distance from each other such that a thread of one screw shaft moves close to a core of the other screw shaft, said screw shafts having a substantially flat portion so that during the rotation said substantially flat portions are mutually scraped preventing a deposit of material on the respective cores.

Advantageously, the degassing screw shafts have substantially square cross section comprising said substantially flat portions alternate to sharp portions. More in detail, the sharp portions of a screw shaft move close to the substantially flat portions of the other and vice-versa, in order to provide a mutual scraping action that prevents a deposit of material on the substantially flat portions ensuring a substantial cleaning of the screw shaft surfaces.

In particular, the degassing screw shafts rotate with different speeds about the respective rotational axes to assist a mutual scraping action.

Advantageously, the degassing screw shafts are equipped with a plurality of protrusions that replace the threads at a portion close to a mixture charging port. The protrusions are arranged on substantially helical tracks, in order to obtain a certain conveyance of from one side to the other, stirring the mixture and assisting also the separation of the solid products from the liquid and gaseous products.

In addition, or alternatively, to the protrusions can be provided cut threads on the degassing screw shafts, always at the inlet of mixture, obtaining substantially a same result.

Advantageously, the degassing screw shafts, at the respective lower ends, are equipped with of substantially frustoconical bases, with conicity oriented towards below, adapted to form, in a base zone close to the lower discharge port, a plug of solid material that prevents a reverse air flow. The plug of material, owing to the continuous rotation of the degassing screw shafts, disintegrates progressively avoiding an excessive accumulation of solid material in the jacket.

Furthermore, the degassing screw shafts may have threads distanced at a pitch suitable to assist the descent of the solid material towards the base of the degassing device.

In particular, an upper discharge port of the degassing device can be in communication with suction means for extracting any liquid and/or gaseous components. In particular, said suction means creates vacuum conditions in the degassing device.

In particular, the charging port of the degassing device is arranged substantially in a middle line of the tubular jacket, in order to free enough leave space both for the liquid and/or gaseous products going up, and for the solid material going down.

According to a particular aspect of the invention, an upper discharge port of the degassing device is connected to a separating device, where any low molecular weight components discharged from the degassing device are separated from heavier components. In a preferred exemplary embodiment, delivery means are provided exiting from said separating device for recirculating said low molecular weight components into said cracking chamber, for assisting the saturation of the bonds of substances being formed in the cracking chamber, which can in turn saturate. This way, is increased the overall saturation rate of the final components which are then more tailored to common energy conversion processes. In other words, before being recirculated into the cracking chamber, the liquid/gaseous components discharged from the degassing device can be subject to one or more separation steps for example by distillation or simply by condensation in order to separate the heavier components from the lighter ones. The latter are then recirculated into the cracking chamber.

Advantageously, the cracking chamber is associated with cooling means adapted to set up a wall temperature profile suitable for maximizing the shear actions.

In particular, at least one temperature sensor can be provided adapted to measure instantly the temperature in the cracking chamber. More in detail, the or each temperature sensor is operatively connected to the means for adjusting said gap in order to increase, or to reduce, the gap responsive to the temperature in the cracking chamber.

### BRIEF DESCRIPTION OF THE DRAWINGS

The invention will be made clearer with the following description of an exemplary embodiment thereof, exemplifying but not limitative, with reference to the attached drawings wherein:

FIG. 1 shows an elevational front partially cross sectional view of the cracking chamber of the apparatus according to the invention, where the material moves from the right towards the left;

FIG. 2 shows an elevational side partially cross sectional view of a screw shaft feeding device of the material towards the cracking chamber FIG. 1;

FIG. 3 shows a first detail of the passageway of the cracking chamber of FIG. 1;

FIG. 4 shows a translation system of the rotor shaft of the apparatus, according to the circle line of FIG. 1, where the material moves from the right towards the left;

FIG. 5 shows an elevational side partially cross sectional view of the degassing device of the apparatus, according to the invention;

FIGS. 5A and 5B show a cross sectional view of the degassing device according to the planes of FIG. 5 indicated with respective dashed lines;

FIG. 6 shows an overall view of a possible exemplary embodiment of the present invention, comprising the feeding device, the cracking chamber and the degassing device, where the material moves from the right towards the left;

FIG. 7 shows a perspective elevational side view of the degassing screw shafts mounted rotatable about respective axes in the degassing device of FIG. 5;

FIG. 8 shows a cross sectional view, according to arrows VII-VII, of the degassing screw shafts of FIG. 7;

FIG. 9 shows diagrammatically a cross sectional view of the cracking chamber for highlighting some technical aspects;

FIG. 10 shows a detail of the cracking chamber of FIG. 2 and of the rotor shaft housed inside for highlighting their ability to translate with respect to each other;

FIGS. 11 and 12 show a partially cross sectional view of an exemplary embodiment of the cracking chamber and of the rotor shaft of FIG. 1;

FIG. 13 shows an elevational side view of the degassing device of FIG. 5 connected by a recirculating duct to the cracking chamber.

### DESCRIPTION OF PREFERRED EXEMPLARY EMBODIMENTS

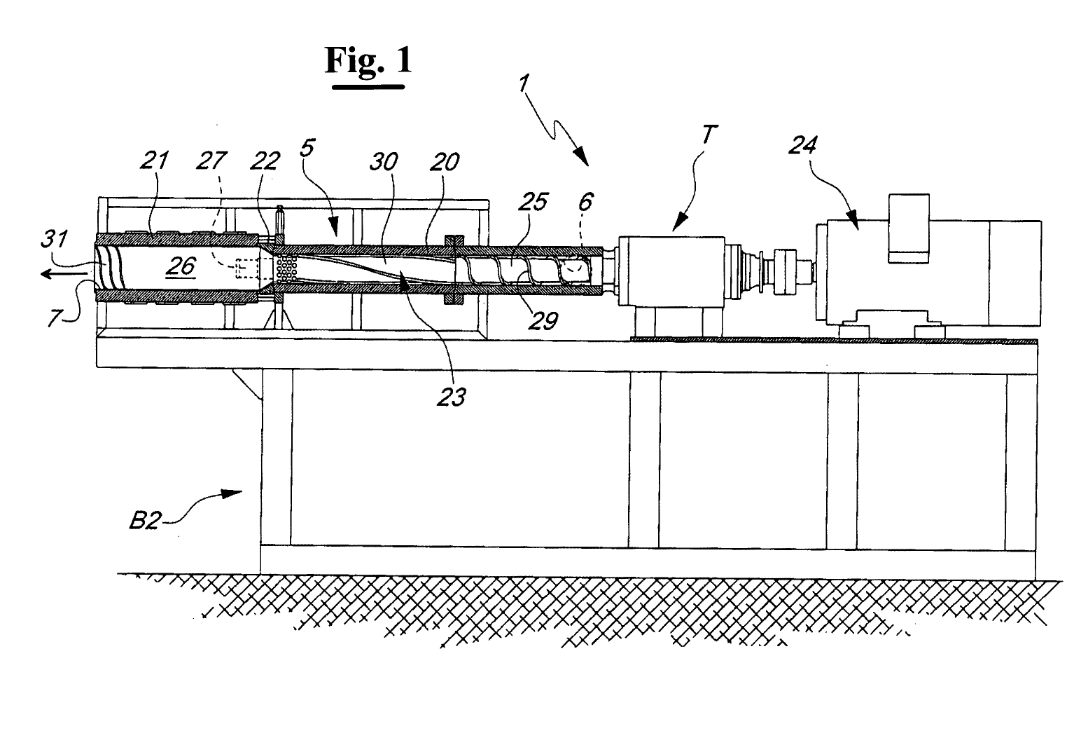

With particular reference to FIG. 1, is indicated globally with the number 1 a transformation device, according to the invention, for cracking organic substances having long chain chemical bonds into a mixture of solid and/or liquid and/or gaseous short chain components.

More in detail, this transformation process is adapted to break chemical bonds, typically C-C, of the molecules of the substances put in the apparatus, occurring at determined temperatures and friction shear values.

The device is adapted to be integrated in a plant, more complex, for making solid, liquid and gaseous components, to use for example as fuel or combustible material.

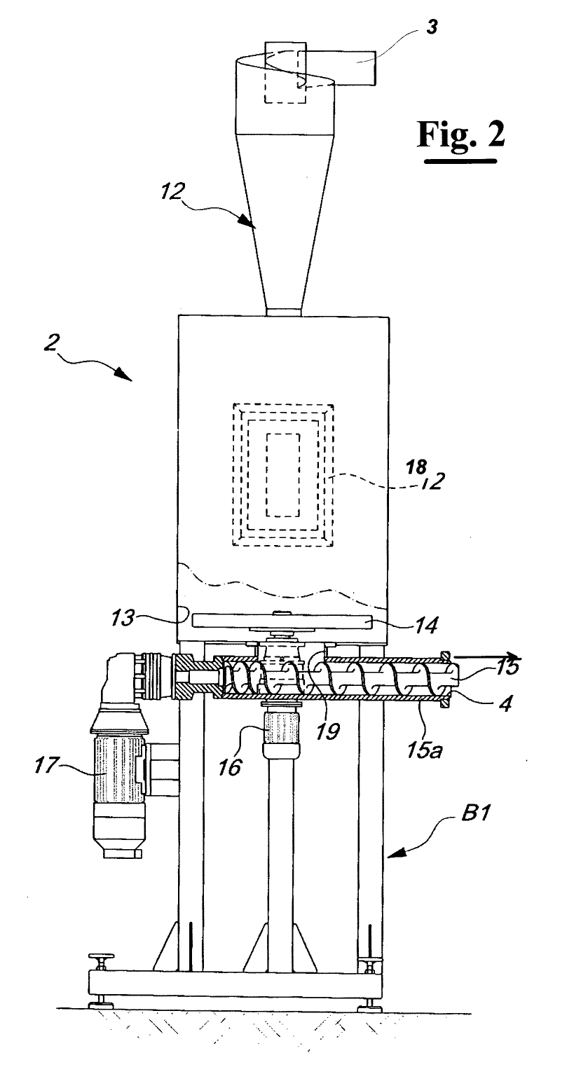

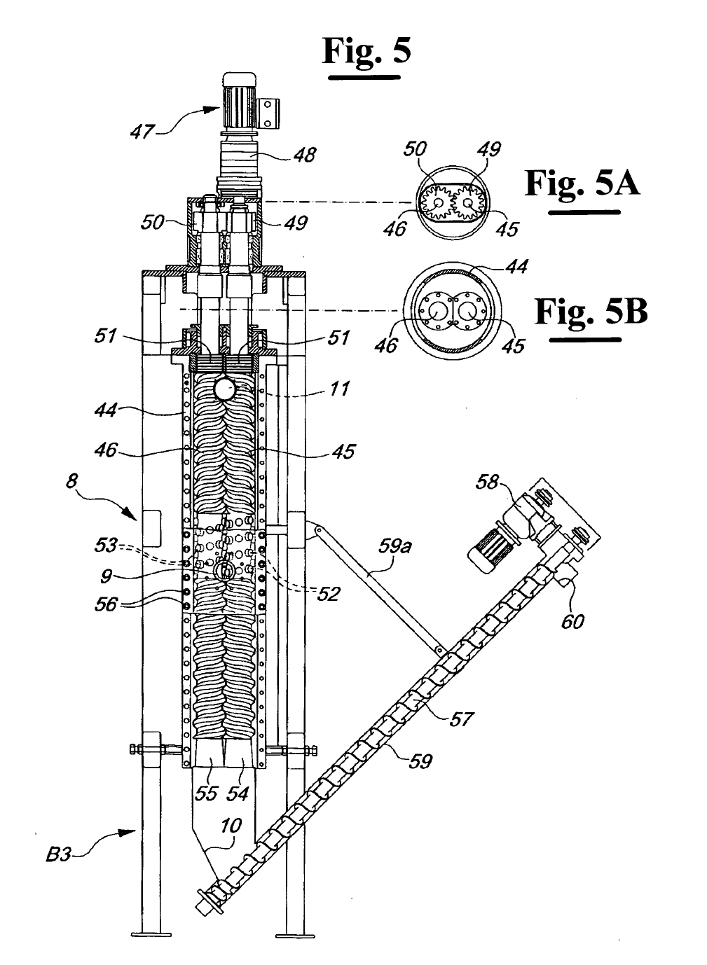

The cracking device of FIG. 1 comprises at least one cracking chamber 5 having compensated pressure substantially tubular walls. Cracking chamber 5 is supported on a base frame portion B2 and has at least one inlet port 6 communicating with a feeding device (FIG. 2) and at least one outlet port 7 for a mixture of transformed components discharged into a degassing device 8 (FIG. 5).

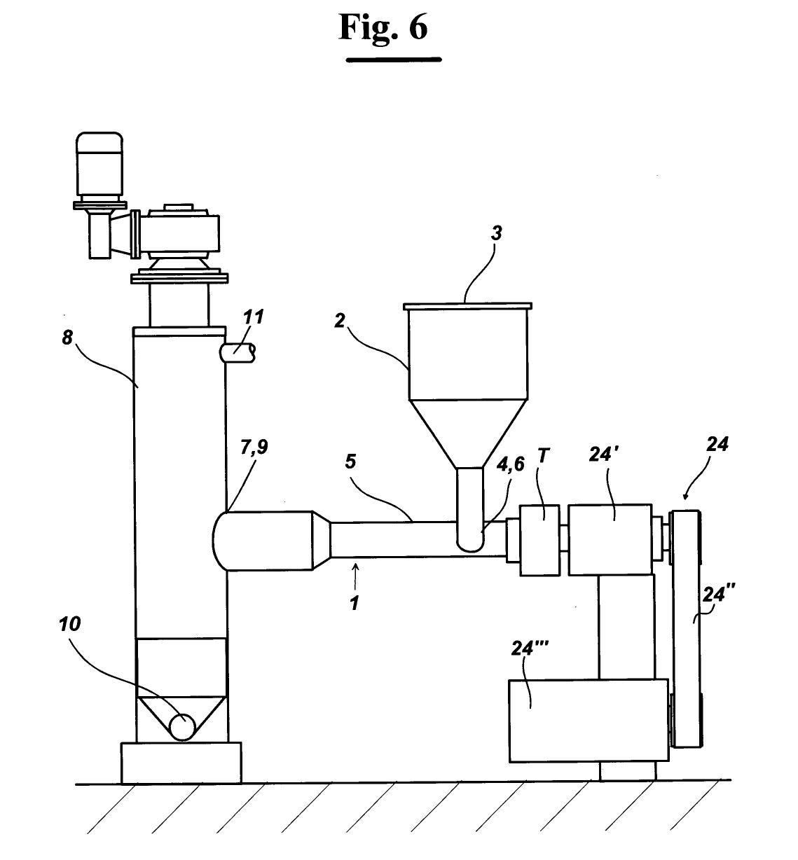

The device 1, in a possible exemplary embodiment of the invention, is, in fact, put in a cracking apparatus shown in the block diagram of FIG. 6, arranged between a feeding device 2 (FIG. 2), with at least one loading port 3 for the substances to be transformed and at least one unloading port 4 for the substances entering inlet port 6, and a degassing device 8 (FIG. 5) having at least one charging port 9, communicating with the outlet port 7 of cracking chamber 5.

The screw shaft feeding device 2 (FIG. 2) is held by a base frame B1 and comprises:
at least one upper cyclone 12 for loading the substances, having at the top loading port 3,
at least one mixing and storing chamber 13 equipped with at least one stirrer 14;
and a first lower screw shaft 15, closed in a tubular housing 15a, defining the unloading port 4 of the compressed substances that communicates with the inlet port 6, arranged laterally with respect to cracking chamber 5 of FIG. 1. The substances are compressed by the screw shaft in order to enter cracking chamber 5 in a substantial absence of oxygen.

The stirrer 14 is rotatably supported at the bottom of mixing chamber 13 and is associated with a respective first rotary actuator 16; the first lower screw shaft 15 is associated instead to a second rotary actuator 17.

The mixing chamber 13 has a side inspection door 18, whereas at the bottom it communicates with a channel 19 for conveying the substances being transformed into tubular housing 15a of first lower screw shaft 15.

Notwithstanding in FIGS. 2 and 6 only one feeding device 2 has been shown, at least two screw shaft feeders can be advantageously provided in parallel, for adjusting different amounts of material according to desired recipes.

With reference again to FIG. 1, cracking chamber 5 is defined by at least one first tubular segment 20, associated to inlet port 6, and by at least one second tubular segment 21, of larger diameter, co-axial to first tubular segment 20, having at one end outlet port 7 for the transformed substances. First tubular segment 20 is preferably split into two portions, connected to each other by a flange.

The tubular transformation chamber 5 comprises, according to the invention, an intermediate portion 22, i.e. a substantially frustoconical passageway, arranged between first tubular segment 20 and second tubular segment 21, which are connected to each other by axial bolts.

The device comprises at least one rotor with helical profile indicated as 23, which in particular is a screw shaft rotatably and coaxially supported in tubular transformation chamber 5, associated with rotary actuating means 24, for example a motor, adapted to cause rotor shaft 23 to rotate at a desired speed, in particular set between 400 and 3000 rpm, preferably between 800 and 2000 rpm. The rotation causes the transformation of the organic substances by mechanical action owing to the frictional shear with the inner surface of cracking chamber 5 and by heating generated by friction. The linear speed with which the rotor shaft sweeps the inner surface of the cracking chamber is a relevant parameter.

Screw shaft 23 comprises a first portion 25, put in the first tubular segment 20, and a second portion 26, of larger diameter, put in second tubular segment 21. Second portion 26 has larger diameter than first portion 25 in order to obtain, at its cylindrical surface, a linear higher speed. This due to the fact that the substances, along second portion 26 of screw shaft 23, have already been partially degraded, in other words they have a lower viscosity, and then a higher friction is necessary (and then a higher resistance) for achieving the conditions (shear stress, temperature) at which a full degradation occurs with a desired production rate. Naturally, the larger is the diameter of second portion 26 and the higher is the capacity of degrading substances with even very low viscosity.

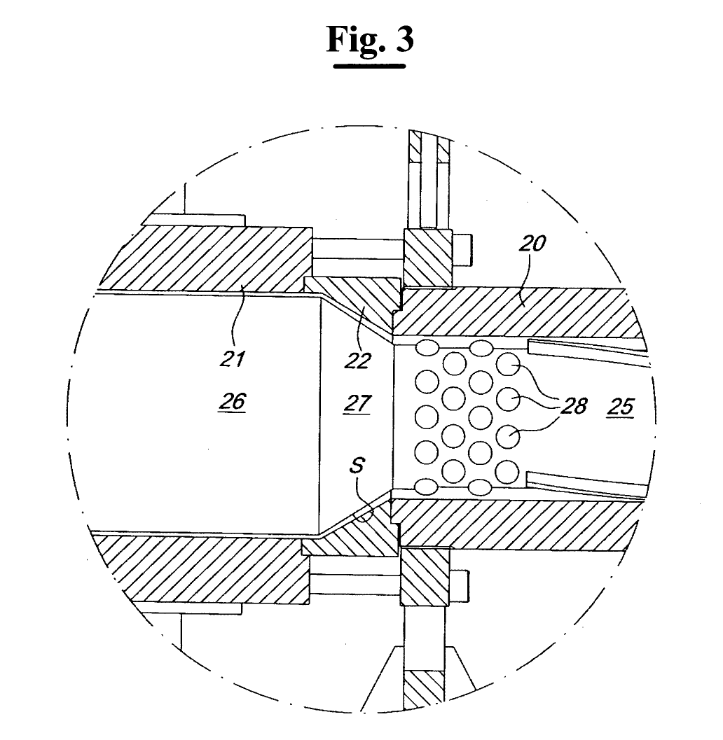

Screw shaft 23 comprises, furthermore, an intermediate portion 27, located between first portion 25 and second portion 26, with substantially frustoconical shape, which is located at intermediate portion 22 of cracking chamber 5, in order to define a gap S (FIG. 3) through which the substances find a way to pass from first tubular segment 20 to second tubular segment 21.

Such gap S has advantageously, according to the invention, an adjustable width as chosen by a user, responsive to particular production requirements, in a way suitable to adjust with enough precision the pressure gradient during the movement of the substances being transformed from first tubular segment 20 to second tubular segment 21, thus compensating the differences of viscosity of the substances same, to achieve the desired transformation conditions. Furthermore, as gap S changes, the time of stay of the material in first tubular segment 20 also varies, achieving in turn an optimal production rate, depending also on the particular chemical-physical characteristics of the material.

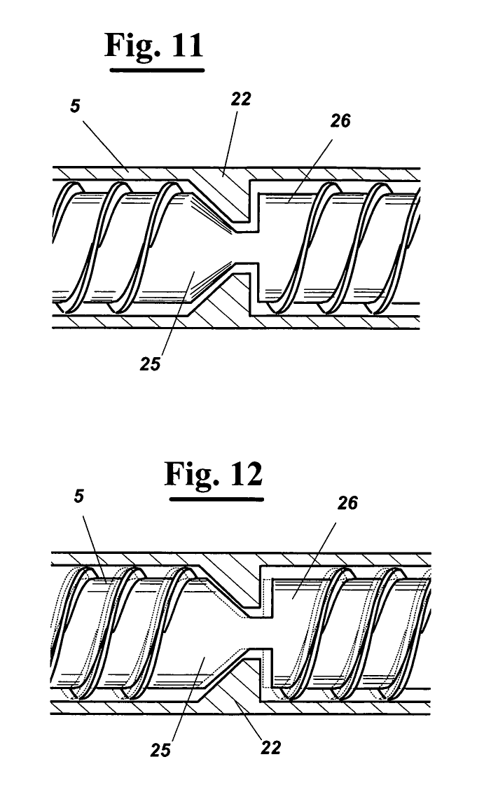

In other words, by changing with continuity the width of gap S it is possible to increase or to decrease as desired the value of the pressure in first tubular segment 20 of chamber 5 (FIG. 10). An increased pressure is obtained by narrowing the cross section S (S₁) and, more in detail, is desirable if the substances being transformed have a relatively low viscosity, and then mixing screw shaft 23, even if with high number of turns, cannot achieve, in cracking chamber 5, the operative conditions at the break of the chemical bonds; a decrease of pressure is instead required if the substances being transformed have a relatively high viscosity. In this case, the cross section increases bringing width value S₁ to a value S₂, with S₂>S₁ (see FIG. 11) so that the mixing screw shaft 23 can achieve, in cracking chamber 5, higher temperatures capable of breaking the bonds, typically C-C, to the speed desired.

This is particularly advantageous, since it has been found experimentally that the substances to treat have very different viscosity values: rubber, for example, keeps a proper viscosity also after that it has been partially degraded, whereas plastics in general, and plastic materials based on polymers having specific transition temperatures, in particular, lose quickly viscosity as degradation proceeds. Therefore, it is relevant to adjust precisely the operative conditions in cracking chamber 5, by controlling the temperature at which the chemical bonds cracking reactions occur in chamber 5. This is further advantageous for non-plastic organic material, such as biomasses of various type, lignin, wood in general, oils and fats, synthetic amines, waste from the leather and meat industry, meat and bone meals, synthetic fibres.

The intermediate portion 27 of screw shaft 23 and the passageway or intermediate portion 22 of cracking chamber 5 are preferably made of a material with high surface hardness, for example tungsten carbide; this reduces the risks of damages if in gap S rigid bodies accidentally pass.

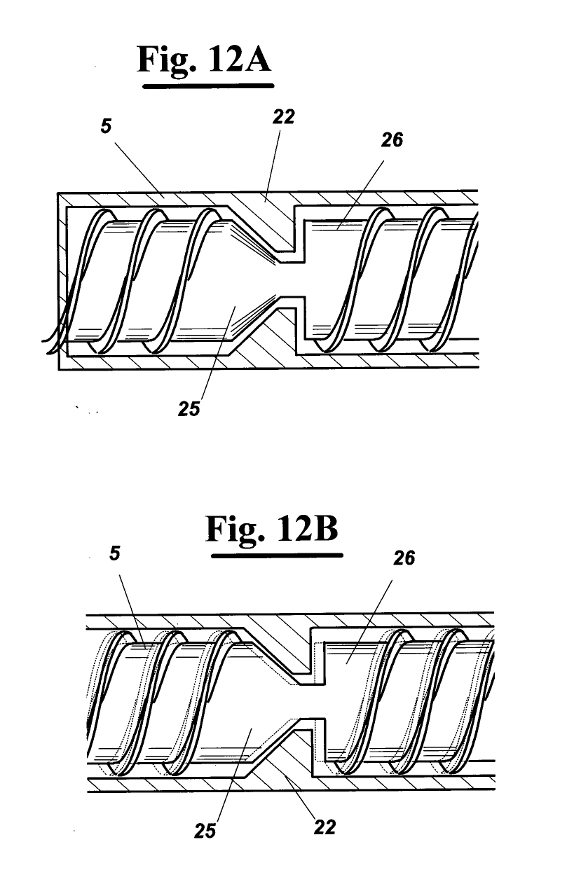

Alternatively, as shown in FIGS. 12A and 12B, changes of gap S can be obtained also without that diameter changes upstream and downstream of intermediate portion 22 of cracking chamber 5, of portions 25 and 26 of screw shaft 23.

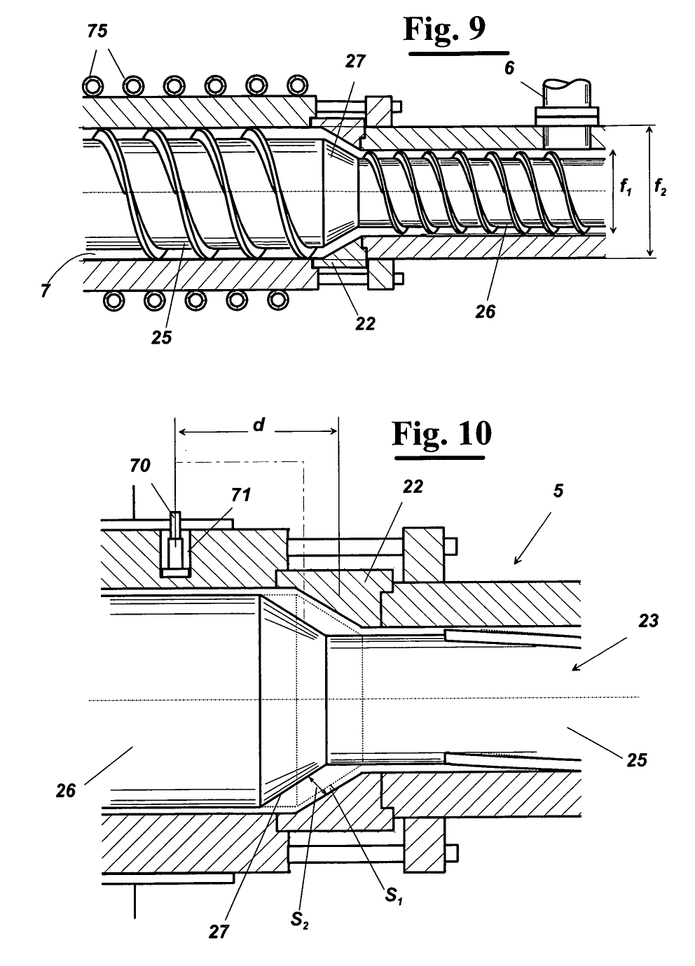

Cracking chamber 5 can be equipped with cooling means 75 (FIG. 9) adapted to keep the walls of chamber 5 at a substantially fixed and normally low temperature. In particular, while the material is conveyed through chamber 5 and as the cracking proceeds, the temperature increases in chamber 5 same. This reduces remarkably the friction of the walls on the material and then the efficiency of the shear effect caused by the rotation of rotor shaft 23. A control of the working temperature of the walls of chamber 5 obtained through cooling means 75 allows, instead, a high braking action of the walls of cracking chamber 5 on the material for all its length, maximizing the transmission of energy on the material in the form of shear stress.

In a possible exemplary embodiment, at an end of first portion 25 (FIG. 3), screw shaft 23 is equipped with a plurality of substantially radial projections 28 adapted to assist centering screw shaft 23 in cracking chamber 5, as well as to enhance mixing the substances.

As shown again in FIG. 1, first portion 25 of screw shaft 23 defines a first thread 29 that extends for a first length, and a second thread 30, of different pitch, which extends for a second length. Second portion 26 of screw shaft 23 defines a third thread 31, of pitch less than first thread 29, and a second thread 30.

Changing the pitch of the first thread 29, of the second thread 30 and of the third thread 31, however, can lead to different results depending on the particular production requirements and on the material species fed to the machine.

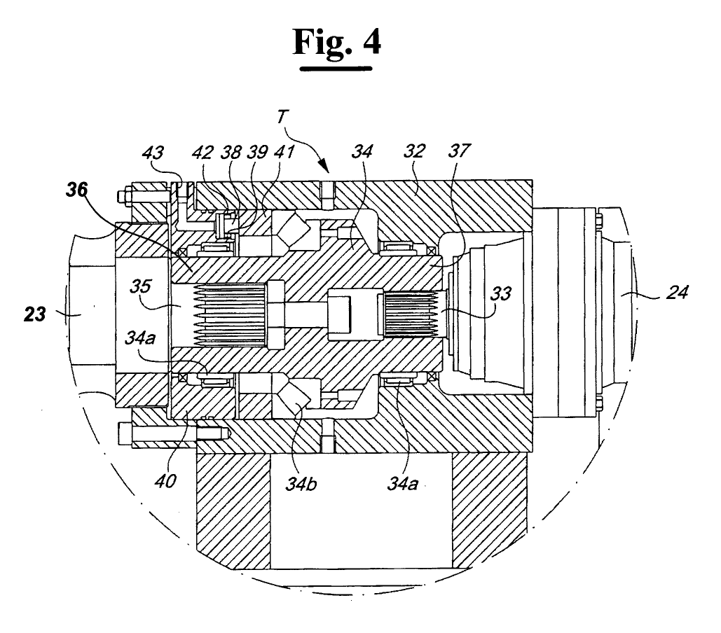

The adjustment with continuity, and as desired by the user, of the width of gap S present between first tubular segment 20 and second tubular segment 21 is achieved, and assisted, by axial bidirectional translation means, indicated as T in FIGS. 1 and 6, acting on screw shaft 23 of cracking chamber 5, and shown in detail in FIG. 4. The axial bidirectional translation means T comprise advantageously a box 32, connected to a driven shaft 33 of a gear motor 24, in which a joint 34 is housed for connection to engagement head 35 of screw shaft 23. More in detail, joint 34, mounted on side radial bearings 34a and on a central thrust bearing 34b thrust, has a first end 36 rigidly connected to engagement head 35 of screw shaft 23, and a second end 37 slidingly coupled to driven shaft 33, for example by means of splined coupling. Bidirectional translation means T comprises preferably a plurality of actuators, in particular hydraulic cylinders, 38 adapted to work on screw shaft 23 in an axial direction opposite with respect to the flow of the substances being transformed in cracking chamber 5. Cylinders 38 are housed in respective cylindrical housings 39 provided on a face of a collar 40 blocked at one end of box 32, and act on a ring 41 that faces directly central thrust bearing 34b. Cylinders 38, of single-acting type biased by respective springs 42, are hydraulically fed by means of respective channels 43 made on collar 40.

The action of cylinders 38 therefore, as said above, causes screw shaft 23 to translate in a direction in order to oppose to the action of the flow of the substances being transformed in cracking chamber 5; the action of the flow of the substances, instead, assists in the translation of screw shaft 23 in the opposite direction; then it is not necessary to provide mechanically this movement, but only controlling it to confer to gap S a desired width.

The above described hydraulic cylinders for the axial translation of screw shaft 23 are equipped advantageously of respective hydro-pneumatic accumulators adapted to dampen pressure peaks in cracking chamber 5, in order to avoid possible shocks on the mechanical parts. Such hydro-pneumatic accumulators can be associated to respective pressure limiting valves, which cause the accumulators to open if in cracking chamber 5 a determined pressure is exceeded.

In particular, to ensure that desired operative conditions remain substantially unchanged in cracking chamber 5, it is possible to monitor instantly its temperature by at least one temperature sensor 70, for example arranged in a housing 71 made in the walls of chamber 5 at a determined distance d from gap S (FIG. 3). Temperature sensor 70 is operatively connected to the means T for the axial translation of the rotor shaft 23. More in detail, if a determined temperature T* in cracking chamber 5 is exceeded, the means T for the axial translation are operated for translating rotor shaft 23 and increasing therefore gap S. This way, the time of stay of the material treated on one side of gap S and then the temperature in the corresponding segment of chamber 5.

With reference to FIG. 5, degassing device 8 is mounted on a base frame B3 and comprises a substantially tubular elongated jacket 44, having an axis arranged vertically, in which two degassing screw shafts 45, 46, are rotatably supported on respective bearings associated with rotary actuators 47, and meshing with each other at the respective threads: the two degassing screw shafts 45, 46 are suitably adapted both to convey towards below the solid components transformed, in order to be expelled through a lower discharge port 10, and to convey towards the above any liquid and/or gaseous components, which are expelled through an upper discharge port 11.

The rotary actuating means 47 comprise a gear motor 48, arranged at the top of jacket 44, mounted on the axis of one of the two degassing screw shafts 45, 46; the rotary actuating means 47 comprise also two gears 49, 50 keyed on both degassing screw shafts 45, 46, which mesh with each other in order to allow the transmission of the motion. At the top end 51 of degassing screw shafts 45, 46 sealing elements are provided adapted to avoid the inlet of air in jacket 44.

More in detail, as shown in FIG. 5, a lower discharge port 10 is provided at the base of the jacket 44, a charging port 9 is arranged substantially at the middle line of the jacket same, whereas an upper discharge port is provided substantially at the top end 51 of degassing screw shafts 45, 46, in order to leave enough space both the liquid and/or gaseous components to go up, and for the solid material to go down. In particular, screw shafts 45, 46, have a helical profile and rotate in order to push towards below the solid material. In the part above charging port 9, the solid material could be dragged by the gaseous components or liquid/vapour components, but the helical shape and the relative speed of rotation of screw shafts 45, 46, would push them back towards below. The helical shape of screw shafts 45, 46 is such that possible residues that adhere on one helical surface would be scraped off by the other helical surface.

Advantageously, substantially at charging port 9 of degassing device 8, degassing screw shafts 45, 46 comprise respective pluralities of protrusions 52, 53 that extend for a predetermined length and replace the threads of the screw shafts i.e. they are arranged on substantially helical tracks. This allows to obtain a certain leak of material from one side to the other, in order to increase its mixing and to assist the separation of the solid material from the liquid and gaseous components, maintaining clean the walls of the degassing device that otherwise would be jammed by the deposit of carbon residues that have been separated from the other two phases.

Alternatively, to protrusions 52, 53 can also be provided cut threads on the degassing screw shafts at the charging port 9, obtaining substantially a similar result.

Degassing screw shafts 45, 46, furthermore, at the respective lower ends, are equipped with substantially frustoconical bases 54, 55 with conicity oriented towards below. Such frustoconical bases 54, 55 assist the formation, at the solid material discharge zone, a plug that prevents a reverse air flow, in determined concentrations, could form in degassing device 8 an explosive mixture. The plug of material that is formed, in particular, owing to the continuous rotation of degassing screw shafts 45, 46, disintegrates progressively avoiding an excessive accumulation of material in jacket 44.

Tubular jacket 44 of degassing device 8 is associated with heating means 56, to assist any liquid and/or gaseous components to go up any solid components to go down.

Always with reference to FIG. 5, degassing device 8 comprises favourably a second screw shaft 57 for discharging the solid components separately from the liquid and/or gaseous components, associated with a respective rotary actuator 58 arranged at a predetermined angle with respect to a vertical direction. The second screw shaft 57 is rotatably supported in an air tight substantially tubular body 59, held at an angle by an articulated arm 59a, communicating with a lower discharge port 10 and having an upper discharge mouth 60. The substantially tubular body 59 and the second screw shaft 57 have a length suitable for preventing a reverse flow of air, owing also to a complete filling with the solid components.

An upper discharge port 11 of degassing device 8 is located preferably in communication with suction means of any liquid and/or gaseous components, not shown in the figures but of essentially traditional type.

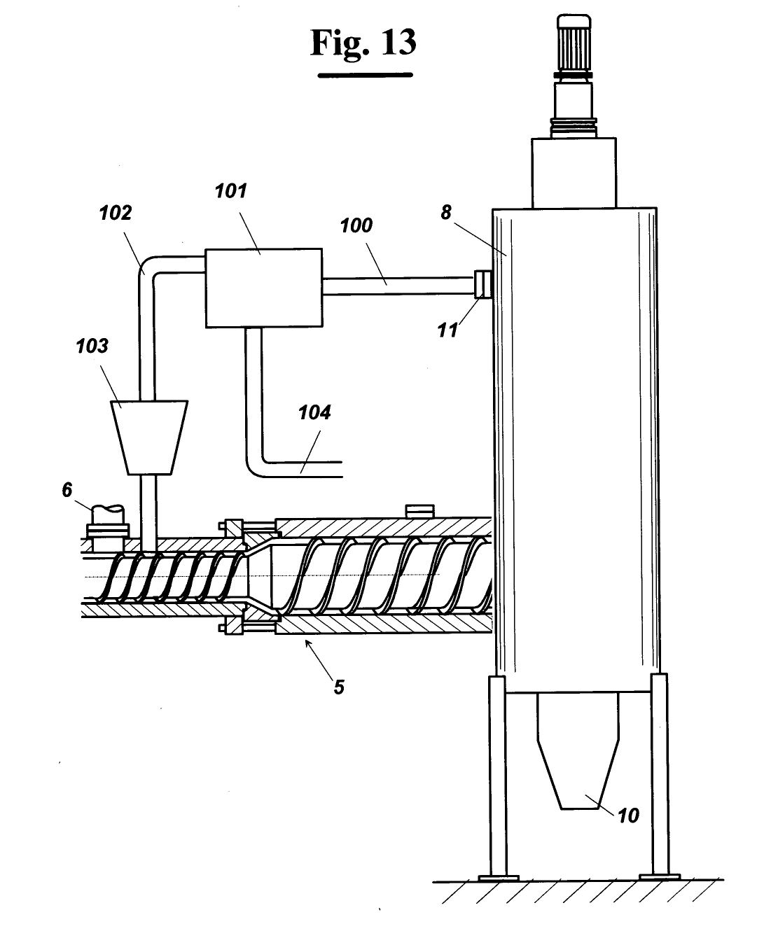

In this connection, as shown in FIG. 13 in an exemplary embodiment of the invention, at the upper discharge port 11 of degassing device 8 a duct 100 can be provided for connection to a separating device 101. Through separating device 101, a part of the lighter fractions can be advantageously recirculated into cracking chamber 5, by a duct 102 and a possible compressor 103. This can assist saturating the unsaturated bonds that tend to form in cracking chamber 5 as the cracking reactions proceed. The other fractions exiting from the separating device 101 reach a storing/converting system provided downstream.

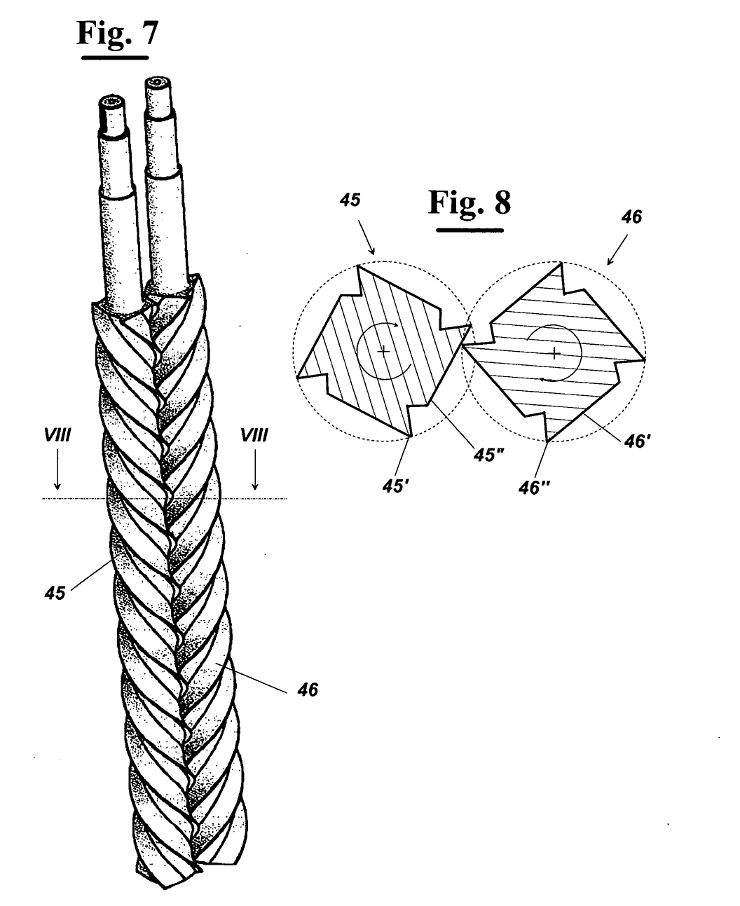

In one exemplary advantageous embodiment of the degassing device of FIG. 5, counter rotating degassing screw shafts 45, 46 (FIG. 7) are arranged at a distance from each other such that the thread 45″ of one screw shaft approaches the core of the other screw shaft at a substantially flat portion 45′ and vice-versa, in order to obtain a scraping action that ensures cleaning the screw shaft flat portions and to limit the accumulation of materials on the cores.

To assist a mutual cleaning action the above described degassing screw shafts 45, 46, can be provided having a substantially square cross section and comprising substantially flat portions 45″, 46″ alternated to sharp portions 45′, 46′. In particular, degassing screw shafts 45 and 46 during the rotation have the sharp portions 45′ of one screw shaft move very close to the substantially flat portions 45″ of the other screw shaft for causing the above described scraping cleaning action (FIG. 8).

The operation of the apparatus, according to the invention is the following. The substances being transformed are loaded by screw shaft feeding device 2 into cyclone 12, from which they pass into mixing chamber 13 and are preliminarily mixed by stirrer 14. From mixing chamber 13 the substances pass then into tubular housing 15a, where they are compressed from the first lower screw shaft 15, in air tight conditions.

Feeding device 2, by means first lower screw shaft 15, feeds the substances into cracking chamber 5, where they are subject to a high speed mixing action owing to cracking screw shaft 23; the presence of gap S adjusts the friction, in particular in the first tubular section 20, so that the transformation temperature reaches a desired value. The substances, through gap S, pass from first tubular section 20 to second tubular section 21, where the transformation is completed, and then they are transferred to degassing device 8. The latter separates, with a suitable combination of temperature values, vacuum and with the aid of degassing screw shafts 45, 46, the solid material, which go down and are then expelled by second screw shaft 57, from liquid and gaseous components, which go up through jacket 44. Degassing device 8 is free from phenomena of accumulation of solid material, since degassing screw shafts 45, 46 are self-cleaning.

As above explained the invention achieves the desired objects.

The device allows to control precisely the optimal transformation temperature of the long chain substances into short chain components independently from the nature of the substances same (in particular, viscosity of the molten material), owing to the possibility of adjusting the pressure, and/or the time of stay in the cracking chamber, and/or the temperature, and then the values of frictional shear.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1. An apparatus for cracking organic substances, for creating a mixture of solid and/or liquid and/or gaseous components, said apparatus comprising a cracking chamber, said cracking chamber having substantially tubular walls and being arranged between an inlet port for said organic substances and an outlet port for said mixture, in said chamber a rotor shaft being arranged associated with rotary actuating means adapted to cause the rotation of said rotor shaft with respect to the walls of said chamber, so that said cracking occurs by friction of said substances during the rotation between the rotor shaft and the walls of said cracking chamber, characterised in that the cracking chamber is defined by a first segment and a second segment, wherein, between said segments, in a direction from said inlet port and said outlet port, said chamber has a passageway from said first segment to said second segment, said rotor shaft having a portion that faces said passageway defining a gap, means being provided for adjusting said gap.

2. Apparatus, according to claim 1, wherein said means for adjusting said gap comprises means for generating a relative axial movement between the rotor shaft and the chamber.

3. Apparatus, according to claim 1, wherein said means for adjusting said gap comprises means for changing the shape of said rotor shaft or of said chamber, in particular, by means of mobile surface portions, such as valve portions, expanding portions, etc., arranged at said passageway and/or at a portion of the rotor shaft that faces said passageway.

4. Apparatus, according to claim 1, where the second segment has a diameter larger than the first segment.

5. An apparatus for cracking organic substances, for creating a mixture of solid and/or liquid and/or gaseous components, said apparatus comprising a cracking chamber, said cracking chamber having substantially tubular walls and being arranged between an inlet port for said organic substances and an outlet port for said mixture, in said chamber a rotor shaft being arranged associated with rotary actuating means adapted to cause the rotation of said rotor shaft with respect to the walls of said chamber, in such a way that said transformation occurs by friction of said substances during the relative rotation between the rotor shaft and the walls of said cracking chamber, characterised in that the cracking chamber is defined by a first segment and a second segment, wherein, between said segments in a direction from the inlet port and the outlet port, the chamber has a passageway from the first segment to the second segment, said second segment having a diameter larger than the diameter of the first segment.

6. Apparatus, according to claim 5, where the ratio between the diameters of said second segment and said first segment is set between 2 and 4.

7. Apparatus, according to claim 1, wherein said passageway has substantially frustoconical shape, with rectilinear, curvilinear or complex profile, and the portion of the rotor shaft that faces the passageway is also frustoconical and is adapted to move for adjusting its engagement degree with the passageway.

8. Apparatus, according to claim 1, wherein said rotor shaft has a plurality of substantially radial projections for centering the screw shaft in the cracking chamber.

9. Apparatus, according to claim 1, wherein said rotor shaft has a helical profile, in particular is a screw shaft, and comprises a first portion that defines a first thread and a second portion that defines a second thread, of different pitch, in particular the second thread having pitch larger than the first thread.

10. Apparatus, according to claim 1, where axial bidirectional translation means are provided comprising a plurality of actuators, in particular hydraulic cylinders, adapted to work on the screw shaft in an axial direction opposite with respect to the flow of the substances being transformed in the cracking chamber.

11. Apparatus, according to claim 10, wherein said hydraulic cylinders have respective hydro-pneumatic accumulators adapted to dampen pressure peaks in the cracking chamber.

12. Apparatus, according to claim 1, wherein said inlet port is supplied by a screw shaft feeding device.

13. Apparatus, according to claim 12, wherein two screw shaft feeders are provided in parallel, for adjusting different amounts of material according to desired recipes.

14. Apparatus, according to claim 1, wherein a degassing device is provided associated with said outlet port, comprising at least one elongated substantially tubular jacket, with substantially vertical axis, in which at least two degassing screw shafts are rotatably supported associated with rotary actuators, said screw shafts being adapted to convey towards below any transformed solid components and towards the above any liquid and/or gaseous components.

15. Apparatus, according to claim 14, wherein said degassing device comprises a second screw shaft for discharging the solid components separately from the liquid and/or gaseous components, associated with a respective rotary actuator and at a predetermined angle with respect to a vertical direction, rotatably supported in a body communicating with a lower discharge port and having an upper discharge mouth.

16. Apparatus, according to claim 14, wherein said degassing screw shafts are arranged at a distance from each other such that a thread of one screw shaft moves close to a core of the other screw shaft, said screw shafts having a substantially flat portion so that during the rotation said substantially flat portions are mutually scraped preventing a deposit of material on the respective cores.

17. Apparatus, according to claim 16, wherein said degassing screw shafts have substantially square cross section comprising the substantially flat portions alternate to sharp portions, in particular the sharp portions of a screw shaft moving close to the substantially flat portions of the other and vice-versa, in order to provide a mutual scraping action that prevents a deposit of material on the substantially flat portions ensuring a substantial cleaning of the screw shaft surfaces.

18. Apparatus, according to claim 14, wherein an upper discharge port of the degassing device is connected to a separating device, where any low molecular weight components discharged from the degassing device are separated from heavier components.

19. Apparatus, according to claim 18, wherein delivery means are provided exiting from said separating device for re-feeding said low molecular weight components in said cracking chamber for assisting the saturation of the bonds of substances being formed in the cracking chamber, which can in turn saturate.

20. Apparatus, according to claim 1, wherein said cracking chamber is associated with cooling means adapted to set up a wall temperature profile suitable for maximizing the shear actions.

21. Apparatus, according to claim 1, wherein at least one temperature sensor is provided adapted to measure instantly the temperature in the cracking chamber, each temperature sensor being, in particular, operatively connected to the means for adjusting said gap in order to increase, or to reduce, the gap responsive to the temperature in the cracking chamber.

22. An apparatus for cracking organic substances, for creating a mixture of solid and/or liquid and/or gaseous components, said apparatus comprising a cracking chamber, said cracking chamber having substantially tubular walls and being arranged between an inlet port for said organic substances and an outlet port for said mixture, in said chamber a rotor shaft being arranged associated with rotary actuating means adapted to cause the rotation of said rotor shaft with respect to the walls of said chamber, in such a way that said cracking occurs by friction of said substances during the relative rotation between the rotor shaft and the walls of said cracking chamber, a degassing device being provided associated with said outlet port, characterised in that an upper discharge port of the degassing device is connected to a separating device, where any low molecular weight components discharged from the degassing device are separated from heavier components, means being provided exiting from said separating device for recirculating said low molecular weight components in said cracking chamber for assisting the saturation of the bonds of substances being formed in the cracking chamber, which can in turn saturate.

23. An apparatus for cracking organic substances, for creating a mixture of solid and/or liquid and/or gaseous components, said apparatus comprising a cracking chamber, said cracking chamber having substantially tubular walls and being arranged between an inlet port for said organic substances and an outlet port for said mixture, in said chamber a rotor shaft being arranged associated with rotary actuating means adapted to cause the rotation of said rotor shaft with respect to the walls of said chamber, in such a way that said cracking occurs by friction of said substances during the relative rotation between the rotor shaft and the walls of said cracking chamber, a degassing device being provided associated with said outlet port, characterised in that said degassing device comprises at least one elongated substantially tubular jacket, with substantially vertical axis, in which at least two degassing screw shafts are rotatably supported associated with rotary actuators, said screw shafts being adapted to convey towards below any transformed solid components and towards the above any liquid and/or gaseous components.

24. Apparatus, according to claim 5, wherein said passageway has substantially frustoconical shape, with rectilinear, curvilinear or complex profile, and the portion of the rotor shaft that faces the passageway is also frustoconical and is adapted to move for adjusting its engagement degree with the passageway.

25. Apparatus, according to claim 5, wherein said rotor shaft has a plurality of substantially radial projections for centering the screw shaft in the cracking chamber.

26. Apparatus, according to claim 5, wherein said rotor shaft has a helical profile, in particular is a screw shaft, and comprises a first portion that defines a first thread and a second portion that defines a second thread, of different pitch, in particular the second thread having pitch larger than the first thread.

27. Apparatus, according to claim 5, wherein said inlet port is supplied by a screw shaft feeding device.

28. Apparatus, according to claim 27, wherein two screw shaft feeders are provided in parallel, for adjusting different amounts of material according to desired recipes.

29. Apparatus, according to claim 5, wherein a degassing device is provided associated with said outlet port, comprising at least one elongated substantially tubular jacket, with substantially vertical axis, in which at least two degassing screw shafts are rotatably supported associated with rotary actuators, said screw shafts being adapted to convey towards below any transformed solid components and towards the above any liquid and/or gaseous components.

30. Apparatus, according to claim 29, wherein said degassing device comprises a second screw shaft for discharging the solid components separately from the liquid and/or gaseous components, associated with a respective rotary actuator and at a predetermined angle with respect to a vertical direction, rotatably supported in a body communicating with a lower discharge port and having an upper discharge mouth.

31. Apparatus, according to claim 29, wherein said degassing screw shafts are arranged at a distance from each other such that a thread of one screw shaft moves close to a core of the other screw shaft, said screw shafts having a substantially flat portion so that during the rotation said substantially flat portions are mutually scraped preventing a deposit of material on the respective cores.

32. Apparatus, according to claim 31, wherein said degassing screw shafts have substantially square cross section comprising the substantially flat portions alternate to sharp portions, in particular the sharp portions of a screw shaft moving close to the substantially flat portions of the other and vice-versa, in order to provide a mutual scraping action that prevents a deposit of material on the substantially flat portions ensuring a substantial cleaning of the screw shaft surfaces.

33. Apparatus, according to claim 29, wherein an upper discharge port of the degassing device is connected to a separating device, where any low molecular weight components discharged from the degassing device are separated from heavier components.

34. Apparatus, according to claim 33, wherein delivery means are provided exiting from said separating device for re-feeding said low molecular weight components in said cracking chamber for assisting the saturation of the bonds of substances being formed in the cracking chamber, which can in turn saturate.

35. Apparatus, according to claim 5, wherein said cracking chamber is associated with cooling means adapted to set up a wall temperature profile suitable for maximizing the shear actions.
